(19) United States
(12) Patent Application Publication
(10) Pub. No.: US 2026/0203301 A1
(43) Pub. Date: Jul. 16, 2026

(54) METHOD AND SYSTEM FOR SELECTIVE ACCELERATION OF REMOTE COPY IN A NETWORK OF STORAGE SYSTEMS

(71) Applicant: HITACHI VANTARA, Ltd., Yokohama-shi (JP)

(72) Inventors: Satish Kumar JAISWAL, Santa Clara, CA (US); Takanobu SUZUKI, San Jose, CA (US); Hiroyuki OSAKI, Los Gatos, CA (US)

(21) Appl. No.: 19/017,353

(22) Filed: Jan. 10, 2025

(51) Int. Cl. G06F 11/14

(52) U.S. Cl. CPC G06F 16/27; G06F 11/1464; G06F 16/1787; G06F 16/273; G06F 16/275; G06F 16/278; G06F 2201/805; G06F 2213/0062

(57) ABSTRACT

Systems and methods described herein involve prioritizing remote copies for acceleration after a disaster-stricken site is operational to enable faster restore and failback operations. The remote copies accelerate processes based on a risk of a Recovery Time Objective (RTO) violation and the impact of failback delays, thereby ensuring timely data restoration and maintaining business continuity. Remote copies that are already in-sync are prioritized for deceleration to free up network resources based on the length of the RTO. Various embodiments remove the maximum bandwidth cap of the highest priority reverse resync operations to accelerate them, or lower the minimum bandwidth cap of the highest priority in-sync remote copies to decelerate them.

### BACKGROUND

### Field

The present disclosure is generally directed to information handling systems, and more specifically, to systems and methods for data protection in computing networks.

### Related Art

Numerous industry and regional standards, such as the HIPAA Security Rule and PCI DSS, mandate the implementation of data recovery strategies to protect essential data for continuous business operations in the event of unexpected disasters or incidents. Enterprises can manage their data recovery in-house or outsource it to specialized storage service providers, a model known as Storage-as-a-Service (STaaS). STaaS has gained popularity due to its flexible pay-per-use model, which alleviates the need for overprovisioning storage capacity and simplifies procurement processes. STaaS providers ensure data protection by maintaining copies of primary data at remote sites, known as secondary data, which are sufficiently distant to remain unaffected by local disasters. Service Level Agreements (SLAs) in STaaS include Recovery Point Objective (RPO) and Recovery Time Objective (RTO). RPO specifies the maximum acceptable amount of data loss, while RTO defines the targeted duration within which business processes must be restored to avoid significant disruptions.

Primary and secondary volumes reside within the same storage system. Applications interact with primary volumes for reading and writing data, while secondary volumes remain inactive unless a failover occurs due to a disaster. This configuration helps distribute the workload and reduces strain on the system. After a disaster, depending on the particular data recovery policy, the primary volume becomes unavailable. The service consumer can either fail over to the secondary volume or restore the primary volume from the secondary volume. If a simple network or power failure results in no or partial data loss, only a differential data copy is required, which can be copied from a secondary volume at the operational site to its corresponding primary volume at the restored site (reverse resync) or from a primary volume in the operational site to its corresponding secondary volume in the recovered site (resync). In cases of total data loss, an initial copy of all data is necessary. Once the affected site is operational, spikes in one-way communication from the operational site to the recovered site can create a network bandwidth bottleneck as concurrent resyncs and reverse resync operations compete for limited network resources.

Since applications requiring primary volume restoration from secondary volumes are at risk of missing their RTOs, to overcome bandwidth congestion and increase restoration time to preserve RTO and mitigate failback delays, priorities should be assigned to remote copies. Existing approaches, however, attempt to reduce interference between remote copies by allocating fixed network bandwidth for remote copies, similarly to I/O performance resources, to prevent competition for resources. Such methods do not prioritize remote copies for post-disaster acceleration after the affected site is operational, which can lead to delays in restore and failback operations, risking RTO violations and impacting dependent applications' performance and functionality.

In contrast, given limited network resources, systems and methods herein prioritize remote copies for acceleration after a disaster-stricken site is operational again to enable faster restore and failback operations. The remote copies are either performing an initial copy or a differential copy from secondary volume to primary volume, based on critical factors to accelerate these processes based on the risk of an RTO violation and the impact of failback delays, thereby ensuring timely data restoration and maintaining business continuity. Remote copies that are already in-sync are prioritized for deceleration to free up network resources based on the length of the RTO. Various embodiments remove the maximum bandwidth cap of the highest priority reverse resync operations to accelerate them and, conversely, lower the minimum bandwidth cap of the highest priority in-sync remote copies to decelerate them.

### SUMMARY

In some aspects of the disclosure, a method for performing remote copy operations, the method comprises, in response to a storage system being operational, using a post-site recovery module to perform steps comprising at least one of: causing a volume management module to recreate or restore a volume of a remote copy pair, or causing a remote copy management module to initiate either reverse resync or resync on remote copy pairs based on either a primary volume or a secondary volume having undergone data loss; determining an acceleration priority for the remote copy pairs, wherein determining the acceleration priority includes at least one of: prioritizing a reverse resync operation over a resync operation and prioritizing a restore operation over a failback operation; in response to calculating an RTO violation risk, prioritizing those remote copy pairs associated with the RTO violation risk, or in response to evaluating a failback delay impact risk, prioritizing those remote copy pairs based on a number of dependent applications for each remote copy pair; and determining a deceleration priority by prioritizing remote copy pairs in in-sync state based on a recovery point objective (RPO).

In some aspects, the method further comprises using a network bandwidth control module to control a network bandwidth of remote copy pairs by performing steps comprising: removing a maximum bandwidth cap of a highest priority reverse resync operation to accelerate a data transfer; and lowering a minimum bandwidth cap of a highest priority remote copy pair in in-sync state to decelerate it and free up network resources for higher priority reverse resync operations, wherein the minimum bandwidth cap is estimated from a historical data, and until a target bandwidth is reached, lowering a minimum bandwidth cap of a next highest priority remote copy pair in in-sync state.

In some aspects, determining the acceleration priority further comprises, in response to a storage system restoration, identifying for acceleration a set of remote copy pairs whose primary volume is affected requiring transfer of data from a secondary volume to a primary volume.

In some aspects, the method further comprises switching a copy mode from a continuous transfer mode to a batch transfer mode without violating the RPO; determining a remaining RTO for each identified remote copy pair by subtracting a restoration time from the RTO; excluding remote copy pairs having a remaining RTO that is negative and indicates a violated RTO; calculating an amount of data to be copied for each identified remote copy pair by comparing a used capacity of the primary volume with a used capacity of the secondary volume; computing a data overflow for each identified remote copy pair by assessing an amount of data to be copied against an allocated network bandwidth and the remaining RTO; determining an additional network bandwidth that is required for each identified remote copy pair to transfer the data overflow within the remaining RTO; and/or prioritizing remote copy pairs based on a lowest network bandwidth requirement.

In some aspects, determining the deceleration priority further comprises discarding remote copy pairs whose RPO is below a threshold. The post-site recovery module may be configured to scan for volumes or remote copy pairs in an error state and trigger a recovery process.

In some aspects, the reverse resync operation represents a copy from a secondary volume to a corresponding primary volume, or a copy from the primary volume to a corresponding secondary volume.

In some aspects, the techniques described herein relate to a non-transitory computer-readable medium for storing instructions for executing a process, the instructions comprising: in response to a storage system being operational, using a post-site recovery module to perform steps comprising at least one of: causing a volume management module to recreate or restore a volume of a remote copy pair, or causing a remote copy management module to initiate either reverse resync or resync on remote copy pairs based on either a primary volume or a secondary volume having undergone data loss; determining an acceleration priority for the remote copy pairs, wherein determining the acceleration priority comprises at least one of: prioritizing a reverse resync operation over a resync operation and prioritizing a restore operation over a failback operation; in response to calculating an RTO violation risk, prioritizing those remote copy pairs associated with the RTO violation risk, or in response to evaluating a failback delay impact risk, prioritizing those remote copy pairs based on a number of dependent applications for each remote copy pair; and determining a deceleration priority by prioritizing remote copy pairs in in-sync state based on recovery a point objective.

In some aspects, the techniques described herein relate to an apparatus, comprising: a processor, configured to: in response to a storage system being operational, using a post-site recovery module to perform steps comprising at least one of: causing a volume management module to recreate or restore a volume of a remote copy pair, or causing a remote copy management module to initiate either reverse resync or resync on remote copy pairs based on either a primary volume or a secondary volume having undergone data loss; determining an acceleration priority for the remote copy pairs, wherein determining the acceleration priority comprises at least one of: prioritizing a reverse resync operation over a resync operation and prioritizing a restore operation over a failback operation; in response to calculating an RTO violation risk, prioritizing those remote copy pairs associated with the RTO violation risk, or in response to evaluating a failback delay impact risk, prioritizing those remote copy pairs based on a number of dependent applications for each remote copy pair; and determining a deceleration priority by prioritizing remote copy pairs in in-sync state based on a recovery point objective.

Aspects of the present disclosure can involve a system, which can involve means for performing steps comprising, in response to a storage system being operational, using a post-site recovery module to perform steps comprising at least one of: causing a volume management module to recreate or restore a volume of a remote copy pair, or causing a remote copy management module to initiate either reverse resync or resync on remote copy pairs based on either a primary volume or a secondary volume having undergone data loss; means for performing steps comprising determining an acceleration priority for the remote copy pairs, wherein determining the acceleration priority comprises at least one of: prioritizing a reverse resync operation over a resync operation and prioritizing a restore operation over a failback operation; means for performing steps comprising, in response to calculating an RTO violation risk, prioritizing those remote copy pairs associated with the RTO violation risk, or in response to evaluating a failback delay impact risk, prioritizing those remote copy pairs based on a number of dependent applications for each remote copy pair; and means for performing steps comprising determining a deceleration priority by prioritizing remote copy pairs in in-sync state based on recovery a point objective.

### BRIEF DESCRIPTION OF DRAWINGS

FIG. 1 illustrates a system for selective acceleration according to various embodiments of the present disclosure.

FIG. 2 is a flowchart illustrating an exemplary process performed by an acceleration priority determination module such as that shown in FIG. 1.

FIG. 3 is a flowchart illustrating an exemplary process performed by a deceleration priority determination module such as that shown in FIG. 1.

FIG. 4 is a flowchart illustrating an exemplary process performed by a network bandwidth control module such as that shown in FIG. 1.

FIG. 5 illustrates a batch mode for selective acceleration according to various embodiments of the present disclosure.

FIG. 6 is a flowchart illustrating an exemplary process for selective acceleration in accordance with various embodiments of the present disclosure.

FIG. 7 illustrates an example computing environment with an example computer device in accordance with various embodiments of the present disclosure.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

In this document the term “copy state” refers to the state a remote copy pair assumes following a remote copy operation. The term “capping” refers to removing a maximum or minimum bandwidth cap.

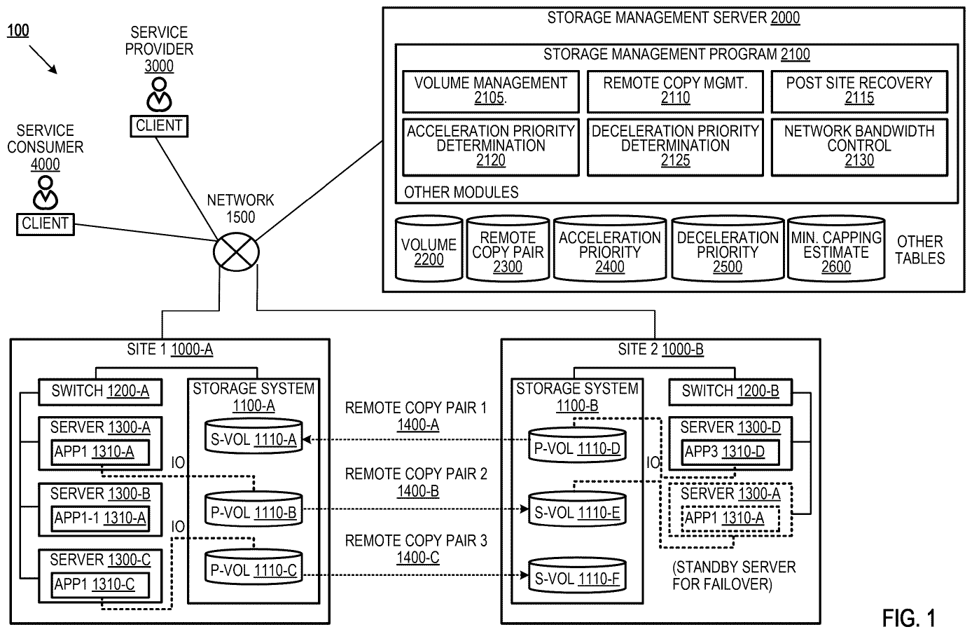

FIG. 1 illustrates a system for selective acceleration according to various embodiments of the present disclosure. System 100 comprises any number of sites 1000-A, 1000-B, storage management server 2000, service provider 3000, and service consumers 4000. Components in system 100 may connect to each other via network 1500 (e.g., WAN, Internet, etc.). Sites 1000-A, 1000-B may be on-premises datacenters or cloud-based IT infrastructure.

In operation, service provider 3000 manages site 1000, storage management server 2000, and network 1500 such as to provide STaaS to one or more service consumers 4000. Service consumer 4000 may request services such as volume provisioning, disaster recovery, and remote backup, e.g., via a self-service portal (not shown) that may be hosted in storage management server 2000 and owned and maintained by service provider 3000.

In embodiments, site 1000-A may have one or more storage systems 1100-A, 1100-B, 1100-C connected to one or many servers 1300-A, 1300-B, 1300-C via one or more switches 1200-A, 1200-B. Service provider 3000 may connect storage system 1100-A in site 1000-A, via network 1500, to storage system 1100-B in site 1000-B, which comprises, volumes 1110-D, 1110-E, 1110-F, and server 1300-D, e.g., to provide disaster recovery and backup capabilities by configuring one or more remote copy pairs 1400-A, 1400-B, 1400-C, respectively.

Volumes (e.g., 1110-A) may be created by a volume management module of storage management program 2100, e.g., in response to a volume provisioning request submitted by service consumer 4000 via the self-service portal. The volumes may be used by an application (e.g., 1310-A) as a container for writing, reading and storing business data. Volumes that are actively used by the applications are known as primary volumes (P-VOL), and their copies are known secondary volumes (S-VOL). Secondary volumes typically remain inactive unless a failover or a restore operation is triggered in the event primary volume becomes unavailable due to a disaster or any other incident. The primary and the secondary volumes may reside together in the same storage system, helping to distribute the workload and allowing for more volumes to be hosted with reduced strain on the storage system.

In embodiments, a copy pair is a logical data copy management unit for copying data from a primary volume to a secondary volume. A remote copy pair refers to a configuration where the primary volume and the secondary volume, used for data duplication and backup, are in separate storage systems. This arrangement is utilized for ensuring data availability and integrity across different physical locations, enhancing disaster recovery capabilities. Remote copy pairs may be created by remote copy management module 2110 of storage management program 2100, e.g., in response to a disaster recovery and/or a remote backup request submitted by service consumer 4000 via the self-service portal.

In embodiments, an application (e.g., 1310-A) may be a software program that runs on a server (e.g., 1300-A) and executes business logic. It may write business data to and read it back from its primary volume. The data recovery strategy in the event of a disaster, which is mandated by various regulations, depends on the criticality of the application to the business.

In embodiments, in a failover recovery mode, for a critical application (e.g., App1 1310-A) that needs to be restored almost immediately, typically having an RTO of under a minute, a standby server (e.g., server 1300-A′) equipped with a copy of the original application (e.g., App 1310-A′) and a copy of the primary volume (e.g., S-VOL 1110-E) is set up at a remote site. Should the original application fail, the business can swiftly switch to this standby server to meet the stringent RTO requirements. Conversely, in a restore recovery mode, setting up a redundant standby server can be costly and may not be economically viable for all applications. Therefore, applications that are less critical (e.g., App2 1310-C and App3 1310-D) and can afford a longer RTO, ranging from several hours to a few days, typically only replicate their primary volumes to a remote site without maintaining a standby server. Without a standby server for immediate failover, these applications must wait until the site hosting the primary volume is operational again before transferring data from the secondary volume back to it. Depending on the time taken to restore the site hosting the primary volume, there is a risk of violating RTO.

In embodiments, storage management server 2000 comprises programs and databases for providing storage services to service consumer 4000. There are no restrictions on where storage management server 2000 should run as long as it is connected to network 1500. For example, storage management server 2000 may run in any one of the on-premises datacenters or in the cloud. The components of this storage management server 2000 may comprise volume management module 2105; remote copy management module 2110; post site recovery module 2115; acceleration priority determination module 2120; deceleration priority determination module 2125; and network bandwidth control module 2130.

In embodiments, volume management module 2105 performs volume-related operations such as creation and periodic status check, in accordance with the information provided either by service consumer 4000 via a self-service portal or mechanically by any other module such as remote copy management module 2110 or post site recovery module 2115. Volume management module 2105 may perform the requested operations and store the information in volume table 2200 (Table 1 below).

In embodiments, remote copy management module 2110 performs remote copy pair-related operations, such as creation, network bandwidth control, and periodic status checks, in accordance with the information provided to it by service consumer 4000 either via self-service portal or mechanically by any other module such as post site recovery module 2115. Remote copy management module 2110 may perform the requested operations and store the information in remote copy pair table 2300 (Table 2 below). It can issue commands to volume management module 2105, e.g., to create a secondary volume required for remote copy pair creation.

Post site recovery module 2115 may perform operations such as volume restoration and remote copy pair restoration after the affected storage system is operational again. It may do so by checking the status of the volumes and/or the remote copy pairs in their respective tables, and then issuing suitable commands to the volume and/or the remote copy management modules 2110. For example, post site recovery module 2115 may issue commands to volume management module 2105 to re-create a volume if it has become irrecoverable. Similarly, it can also issue commands to remote copy management module 2110 to either reverse resync or resync operations based on the status of the remote copy pair. These operations may occur either automatically or be performed by service provider 3000 using an interface provided by this module.

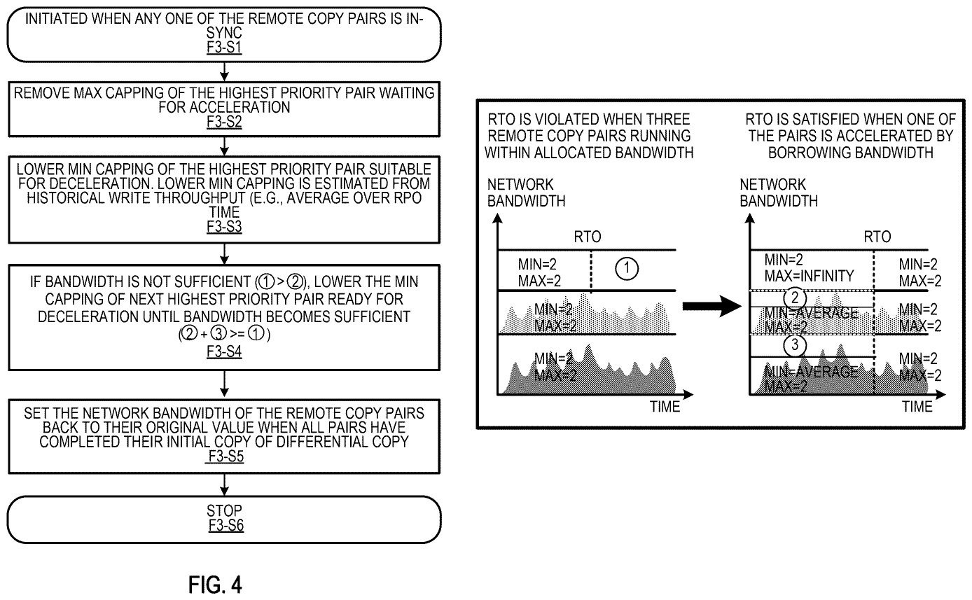

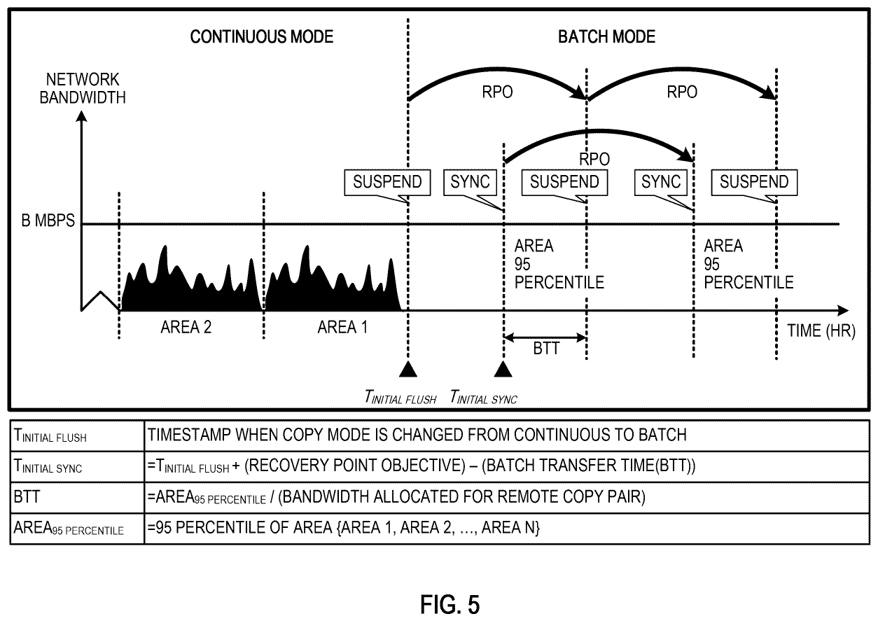

In embodiments, acceleration priority determination module 2120 determines the acceleration priority of remote copy pairs once the affected storage system is operational again, according to the process discussed wither reference to FIG. 4. The acceleration priorities are stored in the acceleration priority table 2400 (Table 3 below). Conversely, deceleration priority determination module 2125 determines the deceleration priority of remote copy pairs once the affected storage system is operational again, according to the process discussed wither reference to FIG. 5. The deceleration priorities are stored in the deceleration priority table 2500 (Table 4 below).

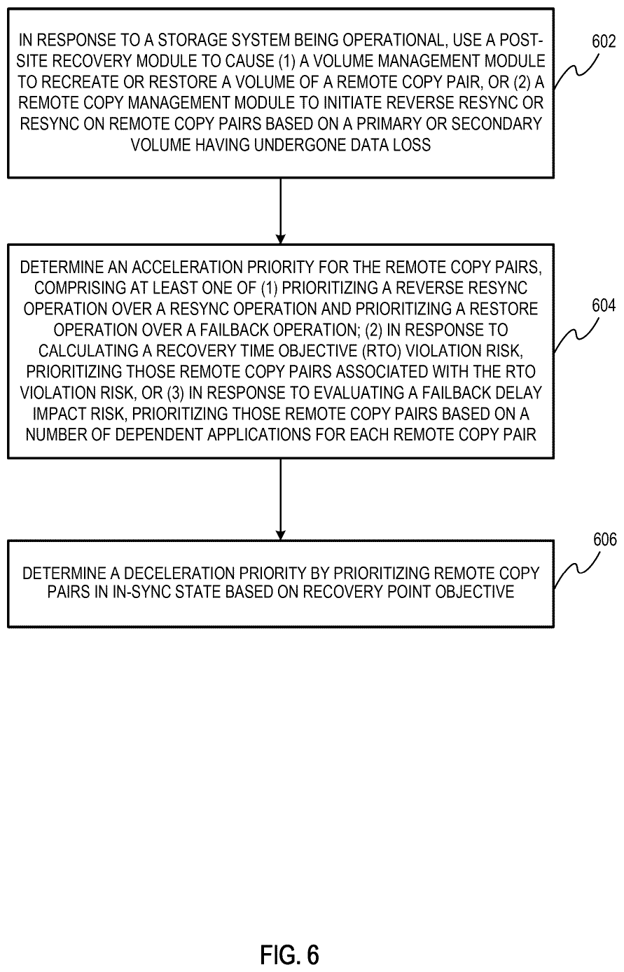

In embodiments, network bandwidth control module 2130 controls the network bandwidth of the remote copy pairs in accordance with the process discussed wither reference FIG. 6. It also estimates the min capping [minimum bandwidth required (min capping)] of the remote copy pair and stores this information in the min capping estimate table 2600 (Table 5 below).

Volume table 2200 stores information about the volumes such as their name, type, capacity, used capacity, max write throughput, storage system, site, status, etc. An exemplary volume table that may be stored in storage management server 2000 is shown in Table 1 below.

Remote copy pair table 2300 stores information about the remote copy pairs such as their name, primary volume name, secondary volume name, recovery type, RTO, RPO, number of dependent applications, minimum/maximum bandwidth, and state. An exemplary remote copy pair table that may be stored in storage management server 2000 is shown in Table 2 below.

In embodiments, acceleration priority table 2400 stores the acceleration priorities of the remote copy pairs. These priorities are determined by acceleration priority determination module 2120 once the affected storage system is operational again. Conversely, deceleration priority table 2500 stores the deceleration priorities of the remote copy pairs. These priorities are determined by the Deceleration priority determination module 2125 once the affected storage system is operational again.

Finally, minimum capping estimate table 2600 holds estimates of the minimum network bandwidth required by a remote copy pair, based on its historical data, such as average write throughput over a period of RPO time interval.

TABLE 1

| | | | | | | max write | storage | | |
|---|---|---|---|---|---|---|---|---|---|
| ID | name | type | capacity | used | | through | system | site | state |
| 1 | site-1-ss-1-pvol-1 | primary | 300 GB | 0 | GB | 10 MB/s | site-1-ss-1 | site-1 | available |
| 2 | site-1-ss-1-pvol-2 | primary | 300 GB | 0 | GB | 15 MB/s | site-1-ss-1 | site-1 | available |
| 3 | site-1-ss-1-pvol-3 | primary | 300 GB | 0 | GB | 20 MB/s | site-1-ss-1 | site-1 | available |
| 4 | site-1-ss-1-pvol-4 | primary | 400 GB | 0 | GB | 25 MB/s | site-1-ss-1 | site-1 | available |
| 5 | site-1-ss-1-pvol-5 | primary | 400 GB | 0 | GB | 25 MB/s | site-1-ss-1 | site-1 | available |
| 6 | site-1-ss-1-svol-1 | secondary | 100 GB | 0 | GB | 10 MB/s | site-1-ss-1 | site-1 | available |
| 7 | site-1-ss-1-svol-2 | secondary | 200 GB | 0 | GB | 25 MB/s | site-1-ss-1 | site-1 | available |
| 8 | site-2-ss-1-svol-1 | secondary | 300 GB | 111 | GB | 10 MB/s | site-2-ss-1 | site-2 | available |
| 9 | site-2-ss-1-svol-2 | secondary | 300 GB | 224 | GB | 15 MB/s | site-2-ss-1 | site-2 | available |
| 10 | site-2-ss-1-svol-3 | secondary | 300 GB | 200 | GB | 20 MB/s | site-2-ss-1 | site-2 | available |
| 11 | site-2-ss-1-svol-4 | secondary | 400 GB | 300 | GB | 25 MB/s | site-2-ss-1 | site-2 | in-use |
| 12 | site-2-ss-1-svol-5 | secondary | 400 GB | 350 | GB | 25 MB/s | site-2-ss-1 | site-2 | in-use |
| 13 | site-2-ss-1-pvol-1 | primary | 100 GB | 50 | GB | 10 MB/s | site-2-ss-1 | site-2 | in-use |
| 14 | site-2-ss-1-pvol-2 | primary | 200 GB | 100 | GB | 25 MB/s | site-2-ss-1 | site-2 | in-use |

Volume management module 2105 records details related to volumes, including their name, type, capacity, utilized space, maximum write speed, associated storage system, site, status, etc. These details can be (1) supplied by service consumer 4000 via self-service portal during a volume provisioning request, such as the volume's name, capacity, max write throughput, storage system, and site, or (2) autonomously updated by volume management module 2105, including information such as volume's type, used capacity, and state.

In embodiments, volumes may be classified into two categories: primary and secondary. Primary volumes are the ones which are actively used by the applications for writing and reading business data and are created in response to the service consumer requests. Secondary volumes remain inactive unless a failover or a restore operation is triggered in the event the primary volumes become unavailable due to a disaster or other incident. These are created in response to disaster recovery or remote backup requests by service consumers. Having both the primary and the secondary volumes within the same storage system helps to distribute the workload, allowing for more volumes to be hosted with reduced strain on the storage system.

Volume management module 2105 periodically monitors the usage of the volumes and updates it in volume table 2200. If the used capacity is zero, it may indicate that the volume is newly created and no data has been written into it. Volume management module 2105 also periodically monitors the status of the volume and updates this information in volume table 2200. The state “creating” refers to the volume being created and not yet available for use. The state “available” refers to the volume being ready and available for use, yet no server has been attached. The state “in-use” refers to the volume being already attached to a server and possibly being used by an application. The state “error” refers to the data in the volume being corrupted, making the volume unreadable or unwritable.

After an affected storage system is operational again, post site recovery module 2115 scans for any volume in an error state and attempts to recover them. If recovery fails, post site recovery module 2115 may create a new volume with same parameters as the original such that data from its replica in a remote site can be copied into it. Table 1 is a snapshot of the volume table immediately after post site recovery module 2115 has finished restoring the volumes.

Remote copy management module 2110 records details related to pairs, including their name, primary volume, secondary volume, recovery type, RTO, RPO, number of dependent applications, minimum and maximum network bandwidth allocated for data transfer, and state. These details can be (1) supplied by service consumer 4000 via self-service portal either during disaster recovery or remote backup request, such as the pair's name, primary volume, recovery type, RTO, RPO and number of dependent applications, or (2) autonomously updated by remote copy management module 2110, including information such as secondary volume, and minimum/maximum network bandwidth allocated for data transfer and state.

As depicted, there are two possible data recovery modes: failover recovery mode and restore recovery mode. The details of these modes are discussed above with reference to the explanation of an application. In a failover recovery mode setup, various embodiments mandate that service consumer 4000 specify the count of applications reliant on the one under consideration for disaster recovery. Table 2 below reflects the number of additional applications that would be affected due to their dependency should the primary application switch to its standby server. A delay in reverting the application to its original state could adversely affect both the performance and functionality of these dependent applications. This value measures the failback delay impact. Service consumer 4000 may either directly supply this value in the self-service portal or it may be deduced from the configuration database of the IT infrastructure.

In such embodiments, the minimum and maximum network bandwidth allocated to a remote copy pair may be set equal to the maximum write throughput of the primary volume. This ensures that there are sufficient network resources for the remote copy. This value is read by network bandwidth control module 2130, which allocates network resources accordingly.

Remote copy management module 2110 may also periodically monitor the status of the remote copy pair and update this information in Table 2.

TABLE 2

| | | | | | | | | | no. of | | | | | |
|---|---|---|---|---|---|---|---|---|---|---|---|---|---|---|
| | | primary | secondary | recovery | | | | | dep. | | | max. | | |
| ID | name | volume | volume | type | RTO | | RPO | | apps | min. BW | | BW | | state |
| 1 | pair-1 | site-1-ss-1- | site-2-ss-1- | restore | 8 | hr | 30 | hr | n/a | 80 | MB/s | 80 | MB/s | copy |
| | | pvol-1 | svol-1 | | | | | | | | | | | |
| 2 | pair-2 | site-1-ss-1- | site-2-ss-1- | restore | 9 | hr | 36 | hr | n/a | 120 | MB/s | 120 | MB/s | copy |
| | | pvol-2 | svol-2 | | | | | | | | | | | |
| 3 | pair-3 | site-1-ss-1- | site-2-ss-1- | restore | 4 | hr | 24 | hr | n/a | 160 | MB/s | 160 | MB/s | copy |
| | | pvol-3 | svol-3 | | | | | | | | | | | |
| 4 | pair-4 | site-1-ss-1- | site-2-ss-1- | failover | 5 | min | 1 | min | 5 | 200 | MB/s | 200 | MB/s | copy |
| | | pvol-4 | svol-4 | | | | | | | | | | | |
| 5 | pair-5 | site-1-ss-1- | site-2-ss-1- | failover | 5 | min | 1 | min | 3 | 200 | MB/s | 200 | MB/s | copy |
| | | pvol-5 | svol-5 | | | | | | | | | | | |
| 6 | pair-6 | site-1-ss-1- | site-2-ss-1- | restore | 6 | hr | 28 | hr | n/a | 80 | MB/s | 80 | MB/s | copy |
| | | svol-1 | pvol-1 | | | | | | | | | | | |
| 7 | pair-7 | site-1-ss-1- | site-2-ss-1- | failover | 5 | min | 1 | min | 6 | 200 | MB/s | 200 | MB/s | copy |
| | | svol-2 | pvol-2 | | | | | | | | | | | |

The state “copy” in Table 2 refers to the either the initial copying phase or the differential copying phase. An initial copy is initiated when one of the volumes in the pair is entirely blank, necessitating a complete data transfer. This situation arises when a pair is freshly established or if one volume within the pair is newly recreated after being completely lost, leading to a full data copy. Conversely, a differential copy is initiated when one volume has accumulated additional data because the pair's synchronization was deliberately paused or an error interrupted the data copying process. The pair utilize maximum network resources during the copy phase either due to initial copy or differential copy.

The state “pair/in-sync” refers to pairs that have completed either the initial or differential copying process and are now continuously updating with live data changes resulting from application writes. The network resource usage by these pairs corresponds to the application's write input/output activity. Typically, these pairs consume less network bandwidth than what was initially allocated to them.

The state “suspend” indicates that the data copying process has been deliberately halted and can be resumed immediately once a resynchronization (resync) or reverse resynchronization (reverse resync) operation is initiated. A resync operation involves copying data from the primary volume to the secondary volume, while a reverse resync entails copying data from the secondary volume back to the primary volume. Depending on the extent of data loss, either an initial copy or a differential copy may start after resync or reverse resync operation is issued.

The state “error” indicates that the data copying process has ceased due to unintended reasons, such as a network connection failure or the storage system becoming non-operational. When a storage system is rendered non-operational due to a disaster or other incidents, the pairs within that system enter an error state.

Once a previously compromised storage system is back online, post site recovery module 2115 scans for any remote copy pairs in an error state to attempt recovery. Post site recovery module 2115 assesses the condition of the volumes involved, rectifies any issues, and then initiates either an initial or differential copy based on the extent of data loss. Consequently, these pairs transition into a copy state. Over time, as the initial or differential copying concludes, some pairs advance to a pair/in-sync state. Embodiments expedite the recovery of pairs still in the copy state by reallocating network resources from those pairs that have already reached the pair/in-sync state.

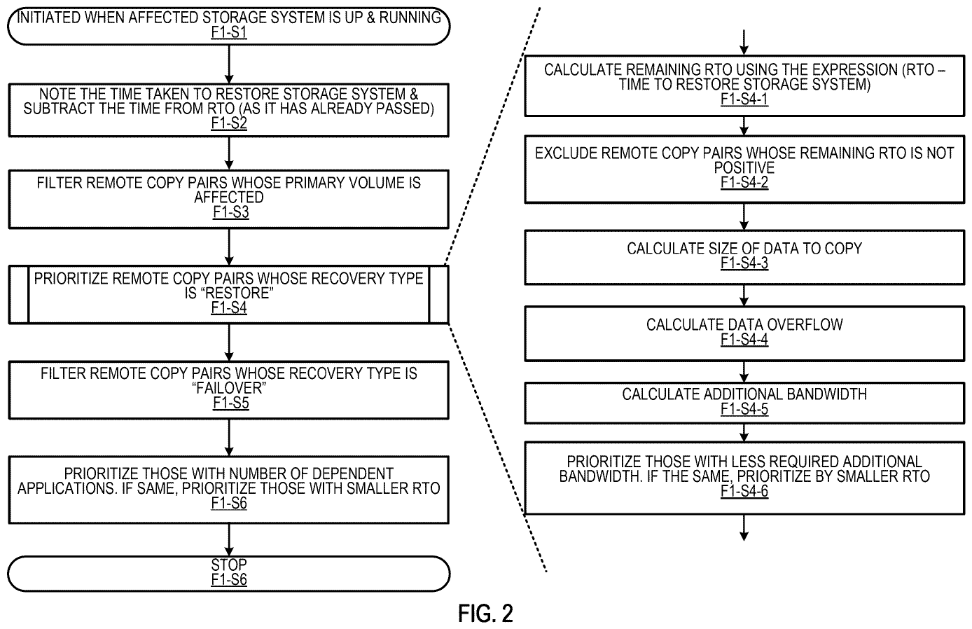

FIG. 2 is a flowchart illustrating an exemplary process performed by an acceleration priority determination module such as that shown in FIG. 1. The process (F1) may start at step F1-S1, when a post site recovery module has finished recovering the volumes and the remote copy pairs in the affected storage system. At this time, the volumes are either in available or in-use state, and the remote copy pairs are either in copy or pair/in-sync state. In an environment where the operations of post site recovery module 2115 are manually performed, a service provider may trigger process F1.

At step F1-S2, the time taken to restore the storage system is noted. This amount of time is subtracted from the RTO as it has already passed.

At step F1-S3, referring to Table 2, the process identifies for acceleration remote copy pairs in the copy state that are copying data from secondary to primary volumes. These pairs are prioritized due to their engagement in either initial or differential copying, both of which are network-intensive processes. Priority is given to pairs moving data from secondary to primary volumes, as the restoring the primary volume is deemed more critical than restoring the secondary volume. Pairs whose primary volume resides in the affected storage system and are copying data from secondary to primary are prioritized.

At step F1-S4, remote copy pairs with a recovery mode set to “restore” are prioritized over those set to “failover”. This is because pairs in “restore” mode have an RTO that still needs to be satisfied, while pairs “failover” mode have their met their RTO due to the immediate failover to the secondary.

Among the remote copy pairs in “restore” recovery mode, those requiring less network bandwidth to meet their RTO are given higher priority. This ensures that scarce network resources are utilized efficiently with high impact.

At step F1-S4-1, using the expression (RTO—time taken to restore storage system), the remaining RTO is calculated.

At step F1-S4-2, remote copy pairs having a negative remaining RTO are excluded because their RTO has already been violated, making acceleration for RTO preservation unnecessary.

At step F1-S4-3, using the expression (used capacity of secondary volume—used capacity of primary volume), the amount of data that needs to be copied is calculated. Three different scenarios can arise:

(1) There is a maximum possible data difference and, hence, an initial copy from the secondary to the primary is required. This can occur when the primary volume suffers a total data loss, e.g., the storage system is destroyed.

(2) There is no data difference and, hence, no copy is required. This can occur when the primary volume suffers no data loss and the remote copy pair is set to “restore recovery mode.” No data loss can occur when the storage system is temporarily down but completely recoverable. Furthermore, if the remote copy pair is set to “restore recovery mode” then there is no write operation to the secondary volume, and thus no data difference can occur.

(3) There is data difference and, hence, a differential copy is required. This can occur when the primary volume suffers a partial data loss.

At step F1-S4-4, using the expression (size of data to copy—allocated bandwidth*remaining RTO), the data overflow is calculated. Data overflow is the amount of data left over if the remote copy pair operates at its allocated network bandwidth for remaining RTO time.

At step F1-S4-5, using the expression (data overflow/remaining RTO), the amount of additional network bandwidth required to transfer the data overflow within the remaining RTO time is calculated.

At step F1-S4-6, higher priority is assigned to pairs requiring less additional network bandwidth. Since network bandwidth is scarce, this ensures that even the smallest amount of free network resource is well utilized with high impact. If the additional bandwidth is the same, then priority is given to pairs with smaller RTOs as they can be completed sooner.

At step F1-S5, remote copy pairs with “failover recovery mode” are selected for acceleration.

At step F1-S6, among the remote copy pairs in “failover recovery mode,” higher priority is given to those with a greater failback delay impact. In this embodiment, failback delay impact is measured by the number of applications dependent on the one under consideration for disaster recovery. Delays in reverting the application to its original state could adversely affect the performance and functionality of these dependent applications. Service Consumer 4000 can either directly supply this value via the self-service portal or it can be deduced from the IT infrastructure configuration database.

At step F1-S7, the priorities are stored in acceleration priority table 2400, and the module stops.

Acceleration priority table 2400 may be stored in storage management server 2000. An exemplary acceleration priority table is shown in Table 3.

TABLE 3

| remote | size of | | data | addi- | no. of | |
|---|---|---|---|---|---|---|
| copy | data | remaining | over- | tional | dep. | |
| pair name | to copy | RTO | flow | BW | apps | priority |
| pair-1 | 111 GB | 3 hr | 3 GB | 2.22 MB/s | — | 1 |
| pair-2 | 224 GB | 4 hr | 8 GB | 4.44 MB/s | — | 2 |
| pair-4 | — | — | — | — | 5 | 3 |
| pair-5 | — | — | — | — | 3 | 4 |

Acceleration priority determination module 2120 calculates and stores the necessary information required for priority setting such as the size of data to copy, remaining RTO, data overflow, additional bandwidth, number of dependent applications, and priority. Refer to the flowchart 200 in FIG. 2 for details on how these values are calculated.

The acceleration priority is used by network bandwidth control module 2130 to accelerate the remote copy pairs.

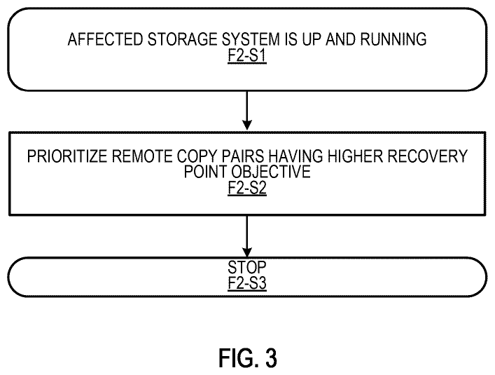

FIG. 3 is a flowchart illustrating an exemplary process performed by a deceleration priority determination module such as that shown in FIG. 1. Process F2 may be initiated by network bandwidth control module 2130, e.g., at step F2-S1, once post site recovery module 2115 has finished recovering the volumes and remote copy pairs in the affected storage system. At this time, the volumes are either in available or in-use state, and the remote copy pairs are either in copy or pair/in-sync state. In environments where the operations of post site recovery module 2115 are manually performed, a service provider may trigger process F2.

At step F2-S2, higher priority is assigned to remote copy pairs with higher RPO as higher RPO allows sufficient time for corrections if something goes wrong. In embodiments, it is also possible to discard remote copy pairs that have an RPO below a certain threshold.

Finally, at step F2-S3, the priorities are stored in deceleration priority table 2500. An exemplary deceleration priority table 2500 that may be stored in storage management server 2000 is shown in Table 4.

TABLE 4

| remote copy pair name | RPO | priority |
|---|---|---|
| pair-2 | 36 hr | 1 |
| pair-1 | 30 hr | 2 |
| pair-6 | 28 hr | 3 |
| pair-3 | 24 hr | 4 |

Deceleration priority determination module 2125 evaluates and stores the deceleration priority for each remote copy pair. Deceleration priority is used by network bandwidth control module 2130 to free up network resource by decelerating the appropriate remote copy pairs.

FIG. 4 is a flowchart illustrating an exemplary process performed by a network bandwidth control module such as that shown in FIG. 1. Process F3 may start at step F3-S1, after one of the remote copy pairs has entered pair/in-sync state.

At step F3-S2, the remote copy pair with the highest priority for acceleration has its maximum capping for network bandwidth removed to facilitate faster data transfer. This may be achieved by setting the maximum bandwidth limit to infinity in remote copy table 2300. The prioritization is determined based on information from the acceleration priority table 2400. The necessity for acceleration at any given moment is assessed according to the pair's current status, as noted in remote copy pair table 2300. If the status is marked as “copy,” then acceleration is deemed necessary.

At step F3-S3, the remote copy pair with the highest priority for deceleration has its minimum capping for network bandwidth lowered to free up network resources. This may be achieved by setting the minimum bandwidth limit to a value derived from statistics (such as average) based on the historical write throughput of the primary volume over the RPO time. Network bandwidth control module 2130 calculates such statistics beforehand and stores them in min capping estimate table 2600. The prioritization is determined based on the information from deceleration priority table 2500. The suitability for deceleration at any given moment is assessed according to the pair's current status, as noted in remote copy pair table 2300. If the status is marked as “pair/in-sync,” then it is suitable for deceleration.

At step F3-S4, if the bandwidth is not sufficient, then network bandwidth control module 2130 decelerates the next highest priority remote copy pair until the bandwidth becomes sufficient. This situation is depicted in the diagram alongside the flowchart.

At step F3-S5, if all the remote copy pairs have finished their initial copy or differential copy, then network bandwidth control module 2130 may reset the network bandwidth values of the remote copy pairs to their original values.

Finally, at step F3-S6, process F3 halts.

TABLE 5

| pair | Average write throughput over RPO time | |
|---|---|---|
| pair-1 | 40 | MB/s |
| pair-2 | 70 | MB/s |
| pair-3 | 120 | MB/s |
| pair-4 | 160 | MB/s |
| pair-5 | 160 | MB/s |
| pair-6 | 70 | MB/s |
| pair-7 | 160 | MB/s |

Min capping estimate table 2600 (Table 5 above) is stored in storage management server 2000. Network bandwidth control module 2130 calculates statistics to estimate the minimum capping of network bandwidth based on historical data beforehand and stores this information in minimum capping estimate table 2600.

As a person of skill in the art will recognize, using network bandwidth control module 2130 to free up network resource by lowering the minimum bandwidth of the remote copy pair to a statistical estimate derived from the historical write throughput of the primary volume may, in some instances, lead to an incorrect bandwidth estimate of that may result in a buffer overflow of the remote copy pair during spikes in data transfer. An overflowing buffer is undesirable as it can lead to a larger time lag between the primary and secondary volume, potentially surpassing the RPO in extreme cases. Therefore, in embodiments, network resources may be freed up by changing the transfer mode from continuous to batch mode without violating the RPO.

FIG. 5 illustrates a batch mode for selective acceleration according to various embodiments of the present disclosure. As previously mentioned, the state “suspend” indicates that the data copying process has been halted and may resume once a synchronization operation is initiated. In embodiments, in a continuous mode, depicted on the left side of the diagram in FIG. 5, data is transferred continuously. Conversely, in batch mode, depicted on the right side of the diagram, data is transferred periodically, utilizing full network resources during the transfer periods.

In operation, the remote copy pair is periodically suspended to free up network resource, with the period being defined by the RPO. The remote copy pair is periodically synchronized to transfer differential data and update data, with the period being defined by the RPO. T_{initial flush} in FIG. 5 represents a timestamp when the copy mode transitions from continuous to batch mode. T_{initial flush} is the first time the suspend operation is executed. Subsequent suspend operations may be performed at regular intervals of RPO. T_{initial synch} represents a timestamp when the first sync is performed. Subsequent synchronization operations may be performed at regular intervals of RPO. An exemplary method to calculate these timings is outlined in the table in FIG. 5.

FIG. 6 is a flowchart illustrating an exemplary process for selective acceleration in accordance with various embodiments of the present disclosure. In embodiments, process for selective acceleration 600 may start at step 602, when, in response to a storage system being operational, a post-site recovery module is use to cause (1) a volume management module to recreate or restore a volume of a remote copy pair, or (2) a remote copy management module to initiate reverse resync or resync on remote copy pairs based on a primary or secondary volume having undergone data loss.

At step 604, an acceleration priority may be determine for the remote copy pairs, comprising at least one of (1) prioritizing a reverse resync operation over a resync operation and prioritizing a restore operation over a failback operation; (2) in response to calculating an RTO violation risk, prioritizing those remote copy pairs associated with the RTO violation risk, or (3) in response to evaluating a failback delay impact risk, prioritizing those remote copy pairs based on a number of dependent applications for each remote copy pair

Finally, at step 606, a deceleration priority may be determined by prioritizing remote copy pairs in in-sync state based on an RPO.

One skilled in the art shall recognize that: (1) certain steps may optionally be performed; (2) steps may not be limited to the specific order set forth herein; (3) certain steps may be performed in different orders; and (4) certain steps may be done concurrently.

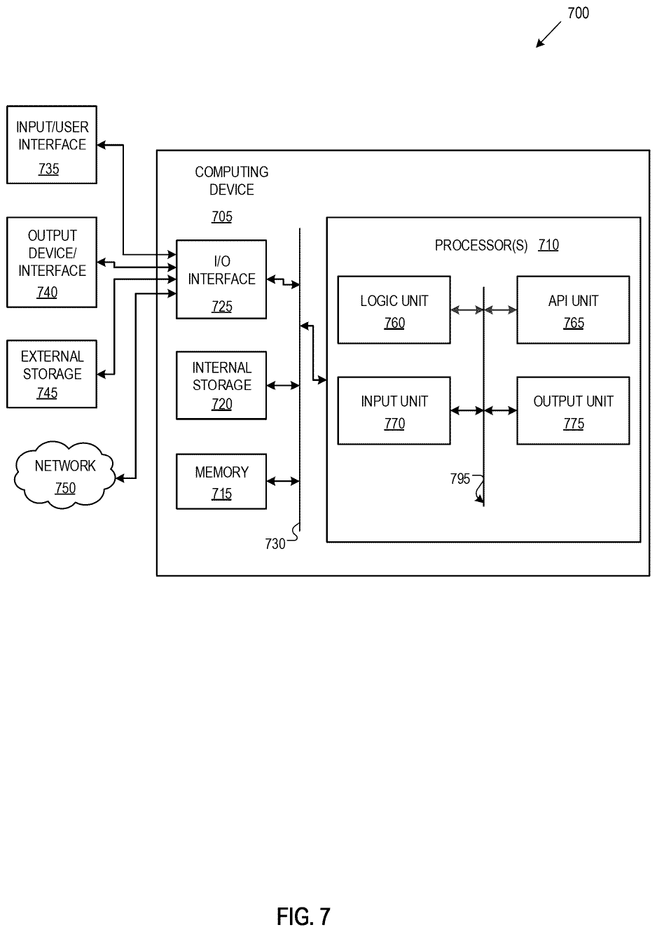

FIG. 7 illustrates an example computing environment with an example computer device suitable for use in some example implementations. Computer device 705 in computing environment 700 can include one or more processing units, cores, or processors 710, memory 715 (e.g., RAM, ROM, and/or the like), internal storage 720 (e.g., magnetic, optical, solid-state storage, and/or organic), and/or I/O interface 725, any of which can be coupled on a communication mechanism or bus 730 for communicating information or embedded in the computer device 705. I/O interface 725 is also configured to receive images from cameras or provide images to projectors or displays, depending on the desired implementation.

Computer device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computer device 705. In other example implementations, other computer devices may function as or provide the functions of input/user interface 735 and output device/interface 740 for a computer device 705.

Examples of computer device 705 may include highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 705 can be communicatively coupled (e.g., via I/O interface 725) to external storage 745 and network 750 for communicating with any number of networked components, devices, and systems, including one or more computer devices of the same or different configurations. Computer device 705 or any connected computer device can be functioning as, providing services of, or referred to as a server, client, thin server, general machine, special-purpose machine, or another label.

I/O interface 725 can include wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, a satellite network, and the like).

Computer device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS) (not shown), in a native or virtual environment. One or more applications can be deployed that include logic unit 760, application programming interface (API) unit 765, input unit 770, output unit 775, and inter-unit communication mechanism 795 for the different units to communicate with each other, with the OS, and with other applications (not shown). The described units and elements can be varied in design, function, configuration, or implementation and are not limited to the descriptions provided. Processor(s) 710 can be in the form of hardware processors such as central processing units (CPUs) or a combination of hardware and software units.

In some example implementations, when information or an execution instruction is received by API unit 765, it may be communicated to one or more other units (e.g., logic unit 760, input unit 770, output unit 775). In some instances, logic unit 760 may be configured to control the information flow among the units and direct the services provided by API unit 765, input unit 770, and output unit 775, in some example implementations described above. For example, the flow of one or more processes or implementations may be controlled by logic unit 760 alone or in conjunction with API unit 765. The input unit 770 may be configured to obtain input for the calculations described in the example implementations, and the output unit 775 may be configured to provide output based on the calculations described in example implementations.

Processor(s) 710 can be configured to execute a method or computer instructions which can involve, as described, for example, with respect to FIG. X

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities to achieve a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer-readable medium, such as a computer-readable storage medium or a computer-readable signal medium. A computer-readable storage medium may involve tangible mediums such as optical disks, magnetic disks, read-only memories, random access memories, solid-state devices, drives, or any other types of tangible or non-transitory media suitable for storing electronic information. A computer-readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the techniques of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the techniques of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for performing remote copy operations, the method comprising:
in response to a storage system being operational, using a post-site recovery module to perform steps comprising at least one of:
causing a volume management module to recreate or restore a volume of a remote copy pair, or
causing a remote copy management module to initiate either reverse resync or resync on remote copy pairs based on either a primary volume or a secondary volume having undergone data loss;
determining an acceleration priority for the remote copy pairs, wherein determining the acceleration priority comprises at least one of:
prioritizing a reverse resync operation over a resync operation and prioritizing a restore operation over a failback operation;
in response to calculating a Recovery Time Objective (RTO) violation risk, prioritizing those remote copy pairs associated with the RTO violation risk, or
in response to evaluating a failback delay impact risk, prioritizing those remote copy pairs based on a number of dependent applications for each remote copy pair; and
determining a deceleration priority by prioritizing remote copy pairs in in-sync state based on a recovery point objective (RPO).

2. The method of claim 1, further comprising using a network bandwidth control module to control a network bandwidth of remote copy pairs by performing steps comprising:
removing a maximum bandwidth cap of a highest priority reverse resync operation to accelerate a data transfer; and
lowering a minimum bandwidth cap of a highest priority remote copy pair in in-sync state to decelerate it and free up network resources for higher priority reverse resync operations, wherein the minimum bandwidth cap is estimated from a historical data, and until a target bandwidth is reached, lowering a minimum bandwidth cap of a next highest priority remote copy pair in in-sync state.

3. The method of claim 1, further comprising switching a copy mode from a continuous transfer mode to a batch transfer mode without violating the RPO.

4. The method of claim 1, wherein determining the acceleration priority further comprises, in response to a storage system restoration, identifying for acceleration a set of remote copy pairs whose primary volume is affected requiring transfer of data from a secondary volume to a primary volume.

5. The method of claim 4, further comprising determining a remaining RTO for each identified remote copy pair by subtracting a restoration time from the RTO.

6. The method of claim 5, further comprising excluding remote copy pairs having a remaining RTO that is negative and indicates a violated RTO.

7. The method of claim 5, further comprising calculating an amount of data to be copied for each identified remote copy pair by comparing a used capacity of the primary volume with a used capacity of the secondary volume.

8. The method of claim 5, further comprising computing a data overflow for each identified remote copy pair by assessing an amount of data to be copied against an allocated network bandwidth and the remaining RTO.

9. The method of claim 8, further comprising determining an additional network bandwidth that is required for each identified remote copy pair to transfer the data overflow within the remaining RTO.

10. The method of claim 5, further comprising prioritizing remote copy pairs based on a lowest network bandwidth requirement.

11. The method of claim 1, wherein determining the deceleration priority further comprises discarding remote copy pairs whose RPO is below a threshold.

12. The method of claim 1, wherein the post-site recovery module is configured to scan for volumes or remote copy pairs in an error state and trigger a recovery process.

13. The method of claim 1, wherein the reverse resync operation represents a copy from a secondary volume to a corresponding primary volume.

14. The method of claim 1, wherein the resync operation represents a copy from the primary volume to a corresponding secondary volume.

15. A non-transitory computer-readable medium for storing instructions for executing a process, the instructions comprising:
in response to a storage system being operational, using a post-site recovery module to perform steps comprising at least one of:
causing a volume management module to recreate or restore a volume of a remote copy pair, or
causing a remote copy management module to initiate either reverse resync or resync on remote copy pairs based on either a primary volume or a secondary volume having undergone data loss;
determining an acceleration priority for the remote copy pairs, wherein determining the acceleration priority comprises at least one of:
prioritizing a reverse resync operation over a resync operation and prioritizing a restore operation over a failback operation;
in response to calculating a Recovery Time Objective (RTO) violation risk, prioritizing those remote copy pairs associated with the RTO violation risk, or
in response to evaluating a failback delay impact risk, prioritizing those remote copy pairs based on a number of dependent applications for each remote copy pair; and
determining a deceleration priority by prioritizing remote copy pairs in in-sync state based on recovery a point objective.

16. The non-transitory computer-readable medium of claim 15, wherein the instructions further comprise using a network bandwidth control module to control a network bandwidth of remote copy pairs by performing steps comprising:
removing a maximum bandwidth cap of a highest priority reverse resync operation to accelerate a data transfer; and
lowering a minimum bandwidth cap of a highest priority remote copy pair in in-sync state to decelerate it and free up network resources for higher priority reverse resync operations, wherein the minimum bandwidth cap is estimated from a historical data, and until a target bandwidth is reached, lowering a minimum bandwidth cap of a next highest priority remote copy pair in in-sync state.

17. The non-transitory computer-readable medium of claim 15, wherein the instructions further comprise switching a copy mode from a continuous transfer mode to a batch transfer mode without violating the RPO.

18. The non-transitory computer-readable medium of claim 15, wherein the instructions further comprise determining the acceleration priority further comprises, in response to a storage system restoration, identifying for acceleration a set of remote copy pairs whose primary volume is affected requiring transfer of data from a secondary volume to a primary volume.

19. An apparatus, comprising:
a processor, configured to:
in response to a storage system being operational, using a post-site recovery module to perform steps comprising at least one of:
causing a volume management module to recreate or restore a volume of a remote copy pair, or
causing a remote copy management module to initiate either reverse resync or resync on remote copy pairs based on either a primary volume or a secondary volume having undergone data loss;
determining an acceleration priority for the remote copy pairs, wherein determining the acceleration priority comprises at least one of:
prioritizing a reverse resync operation over a resync operation and prioritizing a restore operation over a failback operation;
in response to calculating a Recovery Time Objective (RTO) violation risk, prioritizing those remote copy pairs associated with the RTO violation risk, or
in response to evaluating a failback delay impact risk, prioritizing those remote copy pairs based on a number of dependent applications for each remote copy pair; and
determining a deceleration priority by prioritizing remote copy pairs in in-sync state based on a recovery point objective.

20. The apparatus of claim 19, wherein the processor is further configured to use a network bandwidth control module to control a network bandwidth of remote copy pairs by performing steps comprising:
removing a maximum bandwidth cap of a highest priority reverse resync operation to accelerate a data transfer; and
lowering a minimum bandwidth cap of a highest priority remote copy pair in in-sync state to decelerate it and free up network resources for higher priority reverse resync operations, wherein the minimum bandwidth cap is estimated from a historical data, and until a target bandwidth is reached, lowering a minimum bandwidth cap of a next highest priority remote copy pair in in-sync state.
